(19) United States
(12) Patent Application Publication
(10) Pub. No.: US 2007/0149103 A1
(43) Pub. Date: Jun. 28, 2007

(54) Full air-exchanging safety cabinet

(75) Inventors: Chung-Hsien Lu, Hsinchu County (TW); Hao-Ting Zhao, Taichung County (TW); Yu-Ren Shu, Kaohsing County (TW); Jia-Hung Huang, Hsinchu City (TW); Shen-Kun Chang, Chiayi City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/523,633

(22) Filed: Sep. 20, 2006

(30) Foreign Application Priority Data
Dec. 23, 2005 (TW) 94146088

(51) Int. Cl. B08B 15/02

(52) U.S. Cl. 454/57

(57) ABSTRACT

A full air-exchanging safety cabinet is provided, comprising a cabinet body having an accommodating space, an air inlet, an air vent and an experiment operation entrance, an air-feeding blower provided at the air inlet side of the cabinet body, a first air filter for filtering air introduced by the air-feeding blower, an experiment operation zone located under the cabinet body and provided with a working platform, a plurality of slits disposed at opposite sides of the experiment operation zone, a glass plate provided at an outer side of the experiment operation entrance of the cabinet body, a second air filter provided at an upper portion of the cabinet body, a speed and pressure monitoring device located at the air vent side of the cabinet body and connected to the second air filter, and an exhaust system connected to the speed and pressure monitoring device.

### BACKGROUND OF THE INVENTION

1. Field of the Invention

The present invention relates to a full air-exchanging safety cabinet, and more particularly, to a full air-exchanging safety cabinet having excellent airflow barrier design and air filter devices.

2. Description of Related Art

With prosperous developments of biotechnology in recent years, the requirements of experimental equipments for biotechnology researches are also increased rapidly. A biological safety cabinet is one of necessary facilities in a biological laboratory. Most of biological experimental methods are operated manually and the time and period of experiments performed in the biological safety cabinet are often tedious. Moreover, a high-risk virus usually in biological experiments may be dangerous to human beings immediately, and even arising life threatening. Especially in utilizing the toxic chemical substances or high volatile chemical substances with high concentration, a biological safety cabinet with 100% air exhausting without internal airflow circulation is required.

Nowadays, the biological safety cabinet for biotechnology researches has not excellent airflow barrier design, high efficient air filters and speed and pressure monitoring at an exhausting outlet. Designing a full air-exchanging safety cabinet with above-mentioned advantages is a worthy subject for research. And, by proper operations of the full air-exchanging safety cabinet, the toxic chemicals can be prevented from being exhausted to the outside, the safety of operators, testing samples and the environment is secured.

### SUMMARY OF THE INVENTION

The objective of the present invention is to provide a full air-exchanging safety cabinet, which has excellent air-feeding, filtering and exhausting systems and can smoothly exhaust toxic (chemical) gas or toxic substances produced during biotechnology experiments to secure safety of operators, testing samples and the environment.

Another objective of the present invention is to provide a full air-exchanging safety cabinet, which is provided with a speed and pressure monitoring device for real-time monitoring airflow speed and pressure in an exhausting pipe.

Yet another objective of the present invention is to provide a full air-exchanging safety cabinet, which is designed to form full airtight at positions of welding, twisting and sealing as manufacturing for passing a pressure-decaying test and preventing the toxic (chemical) gas from being exhausted.

To achieve the above objectives, the full air-exchanging safety cabinet of the present invention comprises a cabinet body having an accommodating space, an air inlet, an air vent and an experiment operation entrance, an air-feeding blower disposed at the air inlet side of the cabinet body, a first air filter for filtering air introduced by the air-feeding blower, an experiment operation zone located under the cabinet body and provided with a working platform for placing testing samples, a plurality of inlet slits and air-feeding slits disposed at opposite sides of the experiment operation zone, a glass plate disposed at an outer side of the experiment operation entrance of the cabinet body, a second air filter provided at an upper portion of the cabinet body, a speed and pressure monitoring device located at the air vent side of the cabinet body and connected to the second air filter, and an exhaust system connected to the speed and pressure monitoring device. When the exhausting flow of the exhaust system is lager than the air-feeding flow of the air-feeding blower by which air is introduced to the inside of the cabinet body, the airflow passes through the first air filter for filtering and screened by the airflow screen. Then, the airflow is evenly blown to the experiment operation zone, and the airflow in the experiment operation zone is sucked by the air-sucking slits. Then, the airflow passes through the second air filter and the speed and pressure monitoring device, and is exhausted by the exhaust system.

Preferably, the speed and pressure monitoring device further comprises a speed measuring unit and a pressure measuring unit.

Preferably, the exhaust system comprises a wind pipe and a flap pivotably disposed in the wind pipe.

Preferably, the exhaust system further comprises an exhaust blower for connecting the wind pipe.

Preferably, the full air-exchanging safety cabinet of the present invention further has a balustrade plate disposed at an outer side of the inlet slit for supporting the operator's hands.

Preferably, the full air-exchanging safety cabinet of the present invention is further provided with a fairing for influencing the direction and speed of the airflow such that the airflow in the first zone can be uniformly mixed and blown downwardly to the first air filter.

Preferably, the air inlet is further provided with a filter screen for initially filtering air introduced from the outside.

Preferably, the full air-exchanging safety cabinet of the present invention further comprises an airflow screen provided under the first air filter for adjusting the direction and speed of the air. The air-feeding slit is provided on an air-sucking plate, and at least one inner wall of the experiment operation zone is further coated with the photocatalytic material. At least one inner wall of the experiment operation zone comprises a rear inner wall, two inner sidewalls of the experiment zone, a bottom surface of the airflow screen and the air-feeding plate.

Preferably, the full air-exchanging safety cabinet of the present invention further comprises a first zone for making the air flow introduced from the outside by the air-feeding blower being evenly blown to the first sir filter, a second zone for exhausting the air to the outside, and a filter screen provided under the second air filter. At least one inner wall of the second zone is further coated with the photocatalytic material. At least one inner wall inside the second zone comprises a rear inner wall, two inner sidewalls of the second zone, a bottom surface of the airflow screen and the air-feeding plate.

Preferably, an ultraviolet (UV) lamp is further provided under the second air filter.

### BRIEF DESCRIPTION OF THE DRAWINGS

FIG. 1 is a schematic perspective view of a full air-exchanging safety cabinet of the present invention.

FIG. 2 is a schematic front view of the full air-exchanging safety cabinet of the present invention.

FIG. 3 is a schematic appearance of the full air-exchanging safety cabinet of the present invention.

FIG. 4 is a schematic perspective view of a speed and pressure monitoring device, a wind pipe and a flap of the present full air-exchanging safety cabinet.

FIG. 5 is a schematic block diagram of a control system of the present invention.

FIG. 6 is a schematic exploded view of a full air-exchanging safety cabinet of another embodiment of the present invention.

FIG. 7 is a schematic assembled view of the full air-exchanging safety cabinet of FIG. 6.

### DETAILED DESCRIPTION OF THE PREFERRED EMBODIMENTS

While the invention will be described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

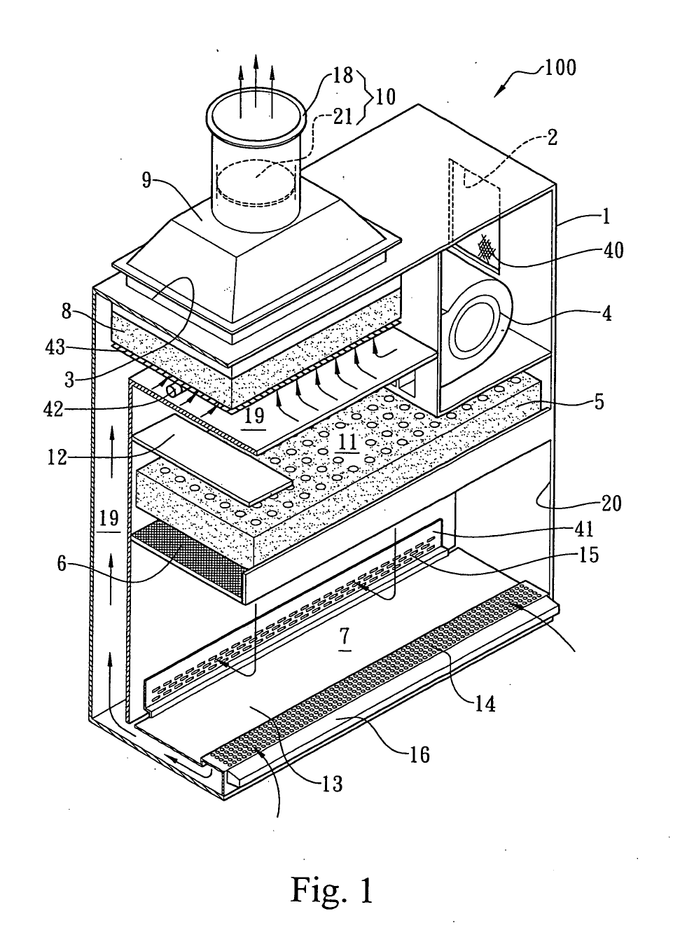

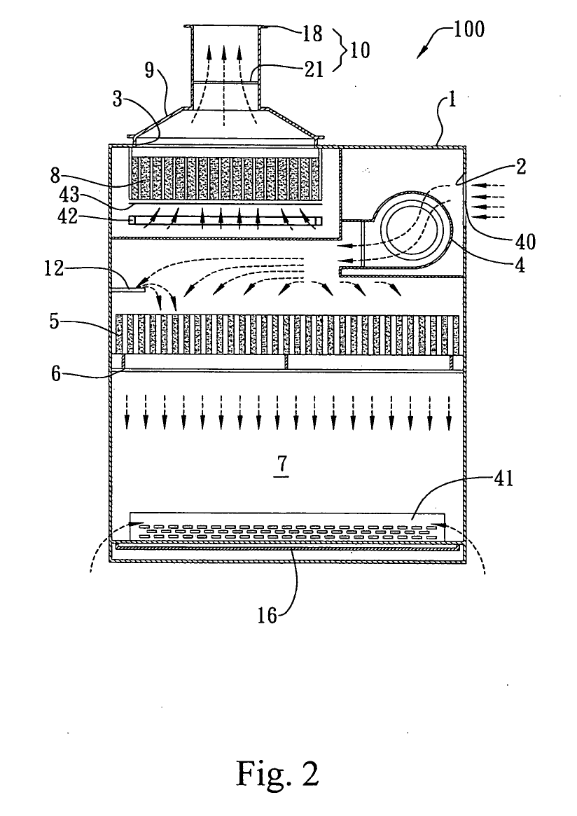

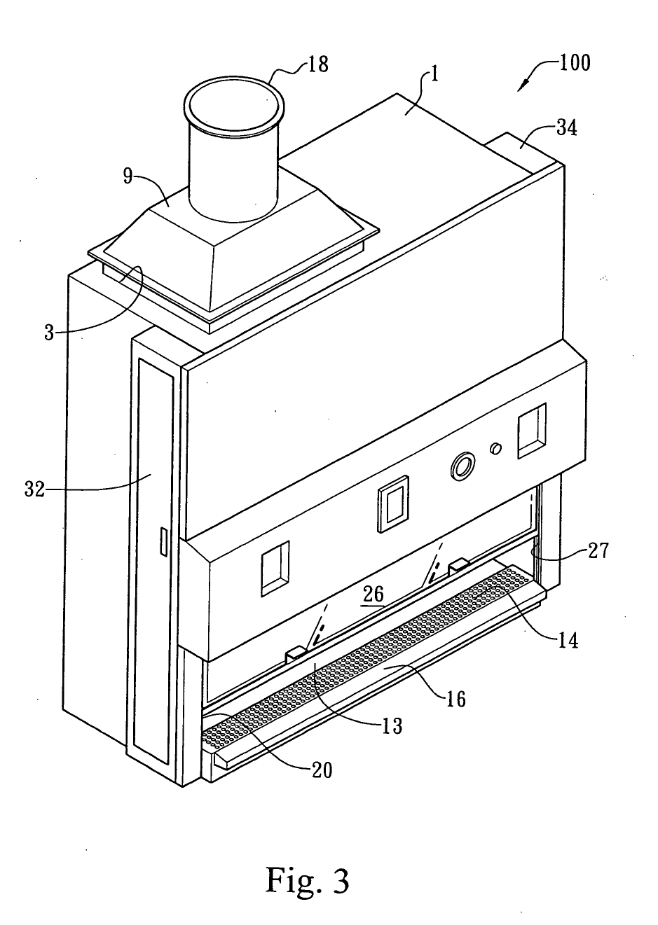

FIG. 1, FIG. 2 and FIG. 3 are respectively schematic perspective view, front view and appearance of a full air-exchanging safety cabinet of the present invention. The full air-exchanging safety cabinet of the present invention comprises a cabinet body 1 having an accommodating space, an air inlet 2, an air vent 3 and an experiment operation entrance 20, an air-feeding blower 4 provided at the air inlet side of the cabinet body 1 (the air inlet 2 is further provided with a filter screen 40 for initially filtering the introduced air), a first air filter 5 for filtering the air introduced by the air-feeding blower 4, an airflow screen 6 provided under the first air filter 5, an experiment operation zone 7 located under the cabinet body I and provided with a working platform 13 for placing testing samples (not shown), a plurality of inlet slits 14 and a plurality of air-sucking slits 15 provided on an air-sucking plate 41 disposed at opposite sides of the experiment operation zone 7, a glass plate 26 provided at an outer side of the experiment operation entrance 20 of the cabinet body 1, a second air filter 8 provided at an upper portion of the cabinet body 1, a speed and pressure monitoring device 9 located at the air vent side of the cabinet body I and connected to the second air filter 8, and an exhaust system 10 connected to the speed and pressure monitoring device 9.

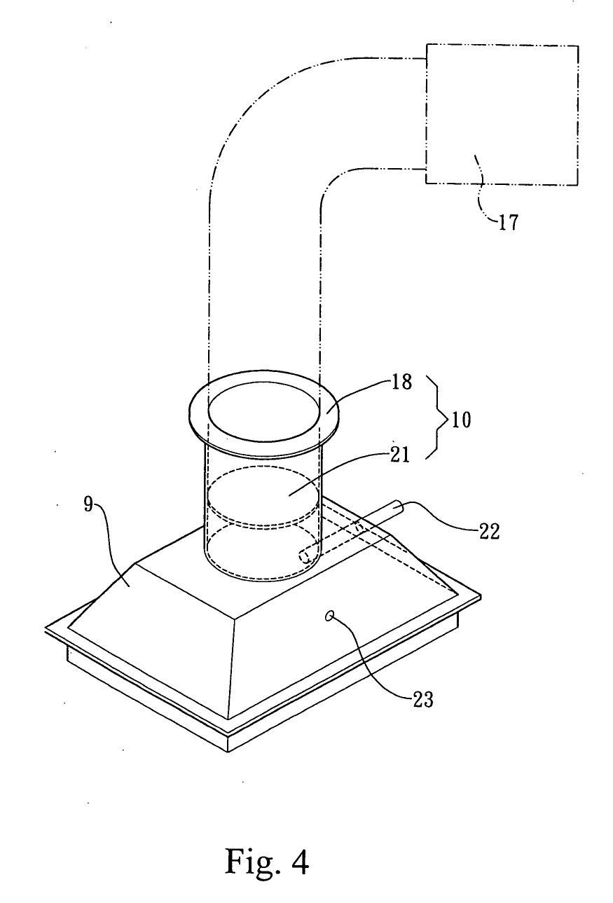

The first zone 11 is further provided with a fairing 12 so that the airflow introduced from the outside by the air-feeding blower 4 can be evenly blown to the first air filter 5. The opposite sides of the platform 13 in the experiment operation zone 7 are respectively provided with a plurality of inlet slits 14 and air-sucking slits 15. The outer side of the inlet slits 14 is further provided with a balustrade plate 16 for supporting the operator's hand during performing experiment. The glass plate 26 can slide upward and downward along rails 27 so as to open or close the cabinet body 1 depending on the operator. The exhaust system 10 comprises a wind pipe 18 and a flap 21 pivotably disposed in the wind pipe 18 to facilitate exhausting the air in the second zone 19 to the outside of the full air-exchanging safety cabinet of the present invention. The flap 21 can open or close by itself depending on the exhausted flow. The full air-exchanging safety cabinet of the present invention further comprises an exhaust blower 17 (referring to FIG. 4) connected to the wind pipe 18 of the exhaust system 10 for exhausting the gas in the cabinet body 1.

Referring to FIG. 1 and FIG. 2, the air introduced from the outside by the air-feeding blower 4 is blown to the inside of the first zone 11 and influenced by the fairing 12 to change its direction and speed so that the airflow inside the first zone 11 can be uniformly mixed and downwardly blown to the first air filter 5. Firstly, the airflow passes through the first air filter 5 for filtering the air and is screened the direction and speed by airflow screen 6. The clean airflow is evenly blown to the experiment operation zone 7 to form vertical laminate airflow for protecting the testing sample placed on the platform 13.

The clean airflow and testing sample react with each other to generate air mixture, which passes through the inlet slits 14 and air-sucking slits 15 and then is introduced into the second zone 19 (this is because the exhausting airflow of the exhaust blower 17 is larger than the air-sucking airflow of the air-sucking blower 4). The air mixture in the second zone 19 passes through the second air filter 8 and becomes clean air by filtering, at this time, the clean air sequentially passes through the speed and pressure monitoring device 9, the wind pipe 18 and the flap 21, and then being exhausted to the outside.

The full air-exchanging safety cabinet 100 of the present invention is further provided with an UV lamp 42 and a filter screen 43 under the second air filter 8. The UV lamp 42 is used as a light source. At least one inner wall of the experiment operation zone 7 is coated with photocatalytic material (not shown). In this embodiment, the rear inner wall, the two inner sidewalls of the experiment operation zone 7, the bottom surface of the airflow screen 6 and the air-sucking plate 41 are coated with photocatalytic material. Likewise, at least one inner wall of the second zone 19 is also coated with photocatalytic material. In this embodiment, the rear inner wall, the bottom inner wall and the two inner sidewalls of the second zone 19 and the bottom surface of the second air filter 8 are coated with photocatalytic material. Thereby, the light source of the UV lamp 42 can be used to sterilize and deodorize the polluted air in the full air-exchanging safety cabinet 100 of the present invention.

Referring to FIG. 4 accompanying with FIG. 1, FIG. 4 is a schematic perspective view of the speed and pressure monitoring device, the wind pipe and the flap of the present invention. In the preferred embodiment of the present invention, the speed and pressure monitoring device 9 is trapezium-shaped. One end of the speed and pressure monitoring device 9 is locked at the air vent side of the cabinet body 1 and connected with the second air filter 8. The other end is inserted with the wind pipe 18 to form full airtight. The wind pipe 18 is also connected with an exhaust blower 17 for exhausting the air in the cabinet body 1. The speed and pressure monitoring device 9 further comprises a speed measuring unit 22 and a pressure measuring unit 23 respectively for measuring the speed and pressure of air filtered by the second air filter 8 such that the operator can real-time monitor the exhausting condition of the wind pipe 18.

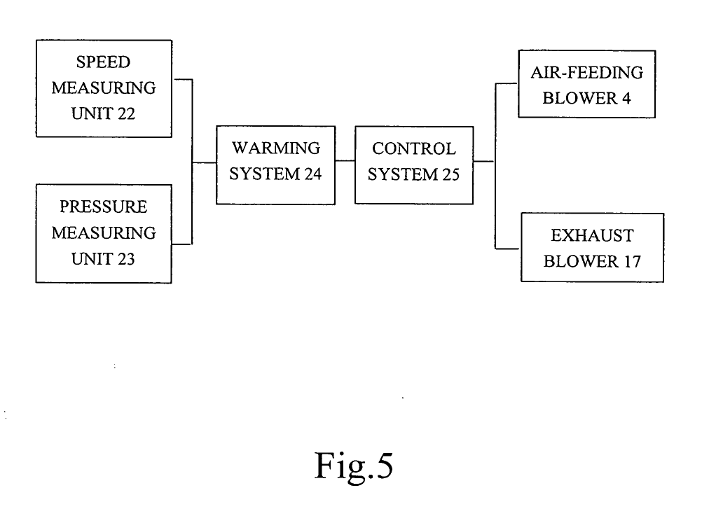

FIG. 5 is a schematic block diagram of the control system of the present invention. In the preferred embodiment, the full air-exchanging safety cabinet 100 of the present invention is further provided with a warming system 24 connected to a control system 25.

When the speed measuring unit 22 detects an abnormal speed of the airflow filtered by the second air filter 8 (please refer to FIG. 1) or the pressure measuring unit 23 detects an abnormal pressure of the airflow, the warming system 24 will be activated (it can be persistently flashing like an indicator light or buzzing like a buzzer) so as to inform the operator of the abnormal phenomena of the exhausting flow or air-feeding flow of the full air-exchanging safety cabinet 100 of the present invention. The toxic gas (substances) would not be exhausted out by the control system 25 to switch on or off the air-feeding blower 4 and the exhaust blower 17, and thus the safety of the operators is secured.

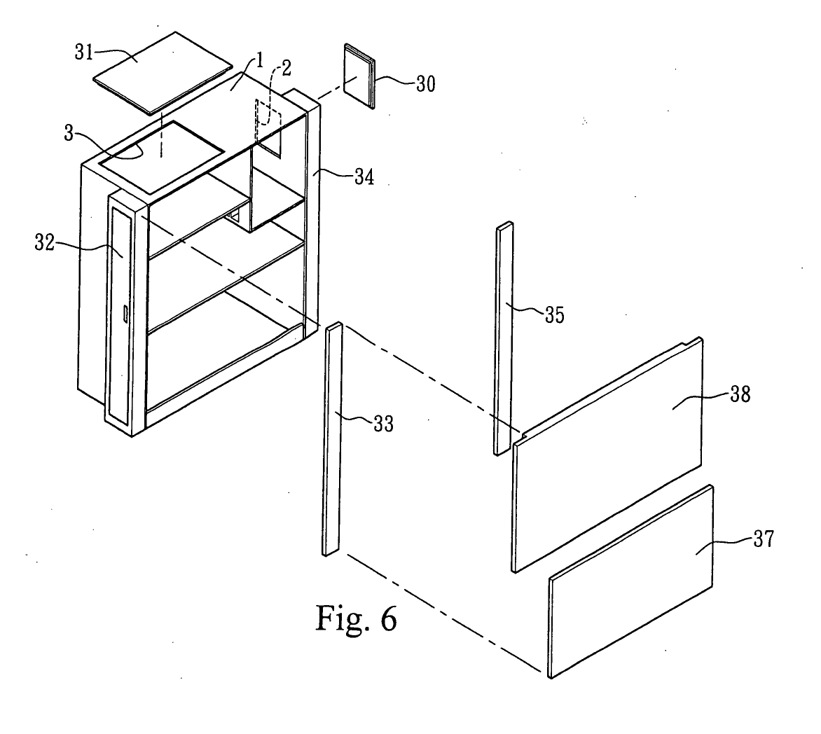

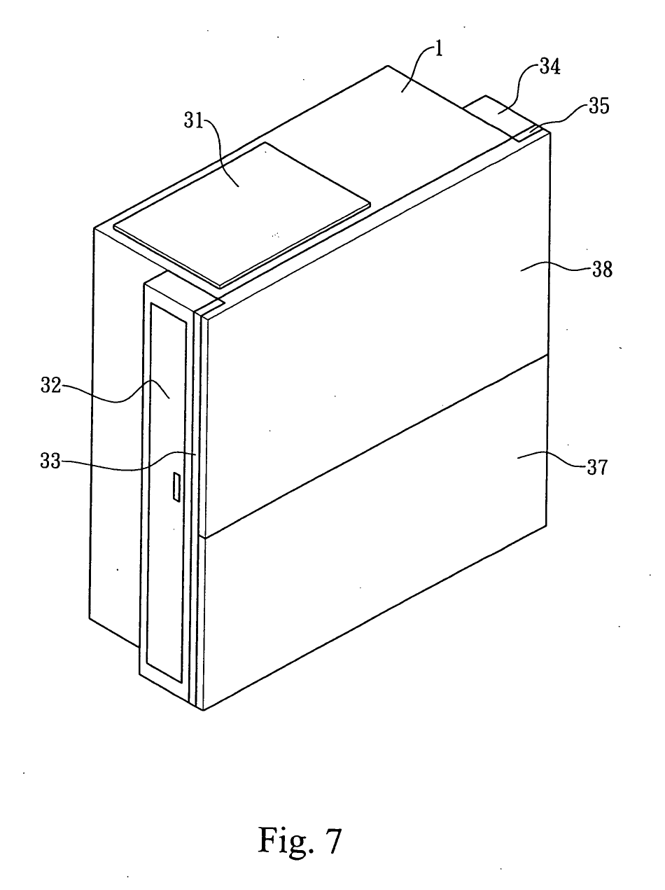

FIG. 6 and FIG. 7 respectively are schematic exploded view and assembled view of the full air-exchanging safety cabinet according to another embodiment of the present invention. In this preferred embodiment of the present invention, it is necessary to firstly pass the pressure-decaying test to insure the airtight at the positions of welding, twisting and sealing of the full air-exchanging safety cabinet 100 as manufacturing. As such, a disassembly method is designed to facilitate performing this test procedure after the full air-exchanging safety cabinet 100 is manufactured. This design utilizes an air-feeding cover 30 locked to the air inlet 2 for closing the air inlet 2, an exhaust cover 31 locked to the air vent 3 for closing the air vent 3, a right-side box 32 fastened to the right side of the cabinet body 1 and a right guide 33 locked to the right-side box 32, a left-side box 34 fastened to the left side of the cabinet body 1 and a left guide 35 locked to the left-side box 34, an experiment operation entrance cover 37 locked to screw holes (not shown) of the right guide 33 and left guide 35 for closing the experiment operation entrance 20, a first cover 38 for closing a plurality of receiving spaces at the upper portion of the cabinet body 1 so as to perform the pressure-decaying test. It can perform biological experiments by the full air-exchanging safety cabinet 100 after insuring the airtight of the full air-exchanging safety cabinet 100 of the present invention at the positions of welding, twisting and sealing.

While the invention has been described by way of examples and in terms of preferred embodiments, it is to be understood that those who are familiar with the subject art can carry out various modifications and similar arrangements and procedures described in the present invention and also achieve the effect of the present invention. Hence, it is to be understood that the description of the present invention should be accorded with the broadest interpretation to those who are familiar with the subject art, and the invention is not limited thereto.

What is claimed is:

1. A full air-exchanging safety cabinet comprising:
a cabinet body having an accommodating space, an air inlet, an air vent and an experiment operation entrance;
an air-feeding blower disposed at the air inlet side of said cabinet body;
a first air filter for filtering air introduced by said air-feeding blower;
an experiment operation zone located under said cabinet body and provided with a platform, wherein a plurality of inlet slits and air-sucking slits is respectively provided at opposite sides of said experiment operation zone;
a glass plate disposed at an outer side of said experiment operation entrance;
a second air filter disposed at an upper portion of said cabinet body;
a speed and pressure monitoring device located at the air vent side of said cabinet body and connected to said second air filter; and
an exhaust system connected to said speed and pressure monitoring device;
wherein when exhausting flow of said exhaust system is larger than air-feeding flow of said air-feeding blower by which air is introduced to the inside of said cabinet body, the air flow passes through said first air filter for filtering and screened by an air flow screen, the air flow is evenly blown to said experiment operation zone, and the air flow in said experiment operation zone is sucked via said air-sucking slits, and then the air flow passes through said second air filter and said speed and pressure monitoring device and is exhausted by said exhaust system.

2. The full air-exchanging safety cabinet of claim 1, wherein said speed and pressure monitoring device further comprises a speed measuring unit and a pressure measuring unit.

3. The full air-exchanging safety cabinet of claim 1, wherein said exhaust system comprises a wind pipe and a flap pivotably disposed in said wind pipe.

4. The full air-exchanging safety cabinet of claim 3, wherein said exhaust system further comprises an exhaust blower connected with said wind pipe.

5. The full air-exchanging safety cabinet of claim 1, wherein a balustrade plate is disposed at an outer side of said inlet slits.

6. The full air-exchanging safety cabinet of claim 1 further comprising a fairing.

7. The full air-exchanging safety cabinet of claim 1, wherein said air inlet is further provided with a filter screen.

8. The full air-exchanging safety cabinet of claim 1, wherein further comprises an airflow screen disposed under said first air filter, and said air-sucking slits is disposed on an air-sucking plate, and at least one inner wall of said experiment operation zone is coated with photocatalytic material, wherein at least one inner wall in said experiment operation zone comprises a rear inner wall, two inner sidewalls of said experiment zone, a bottom surface of said airflow screen and an air-feeding plate inside said experiment zone.

9. The full air-exchanging safety cabinet of claim 1 further comprising a first zone for introducing air flow from the outside by said air-feeding blower such that the air flow is evenly blown to said first air filter, a second zone for exhausting air to the outside, and a filter screen disposed under said second air filter, and at least one inner wall of said second zone coated with photocatalytic material, and at least one inner wall inside said second zone comprises a rear inner wall, two inner sidewalls of said second zone, a bottom surface of said airflow screen and said air-feeding plate inside said second zone.

10. The full air-exchanging safety cabinet of claim 1, wherein a UV lamp is disposed under said second air filter.

11. The full air-exchanging safety cabinet of claim 9, wherein a UV lamp is disposed under said second air filter.
